(19) United States
(12) Patent Application Publication
(10) Pub. No.: US 2012/0045383 A1
(43) Pub. Date: Feb. 23, 2012

(54) Method for the Manufacture of Photovoltaic Grade Silicon Metal

(76) Inventors: Andrew Matheson, Belmont, MA (US); John W. Koenitzer, Carlisle, MA (US)

(21) Appl. No.: 13/225,770

(22) Filed: Sep. 6, 2011

Related U.S. Application Data
(63) Continuation of application No. PCT/US2010/027559, filed on Mar. 17, 2010.
(60) Provisional application No. 61/162,050, filed on Mar. 20, 2009.

(51) Int. Cl. C01B 33/02; C01B 33/037; C01B 33/021

(52) U.S. Cl. 423/350; 423/349

(57) ABSTRACT

Disclosed is method for the production of silicon metal of a purity sufficient for the manufacture of commercial grade photovoltaic devices, by first reacting liquid silicon tetrachloride with molten sodium metal, and then by processing the reaction product to remove from the silicon metal, those reaction products which would be detrimental to the performance of the produced silicon metal in commercial grade photovoltaic devices used to generate electric power for commercial sale.

### CROSS-REFERENCE TO RELATED APPLICATIONS

This Application is a continuation of PCT Application No. PCT/US2010/027559 filed 17 Mar. 2010 and published in the English language on 23 Sep. 2010 as PCT Publication No. WO 2010/107850. The PCT Application claims priority from U.S. Provisional Application Serial No. 61/162,050 filed 20 Mar. 2009. The disclosures of these applications are hereby incorporated herein by reference.

### FIELD OF THE INVENTION

This invention relates to the production of silicon metal of a purity sufficient for the manufacture of commercial photovoltaic devices, by first reacting liquid silicon tetrachloride with molten sodium metal, and then by processing the reaction product to remove those contaminant products that would be detrimental to the performance of the silicon metal in commercial photovoltaic devices used to generate electric power for commercial sale.

### BACKGROUND OF THE INVENTION

Polycrystalline silicon metal (also referred to as polysilicon) is the most commonly used semiconductor for the manufacture of photovoltaic devices. Polysilicon is today produced predominantly by the Siemens process, in which trichlorosilane decomposes, at high temperature and in the presence of silicon metal, into a mixture of chlorolisanes, other gases, and silicon metal. While the Siemens process produces silicon metal of sufficient purity for semiconductor applications, in which silicon purities greater than 99.99999% are required, the polysilicon produced by the Siemens process has also been used in the manufacture of photovoltaic devices. However, in a photovoltaic device, lower silicon purities are acceptable, and 99.999%-99.9999% pure silicon metal is generally considered acceptable for such devices, as these levels are generally regarded as being photovoltaic grade.

PCT Publication No. WO 2009/018425 published 5 Feb. 2009 discloses a process for the production of high purity elemental silicon by reacting silicon tetrachloride with a liquid metal reducing agent in a two reactor vessel configuration. The first reactor vessel is used for reducing the silicon tetrachloride to elemental silicon, resulting in a mixture of elemental silicon and reducing metal chloride salt while the second reactor vessel is used for separating the elemental silicon from the reducing metal chloride salt. The elemental silicon produced using this invention is of sufficient purity for the production of silicon photovoltaic devices or other semiconductor devices.

The process of this invention has been developed to provide the photovoltaic industry with a source of polysilicon pure enough to meet the industry's purity requirements for the production of photovoltaic devices used to generate electric power for commercial sale, without necessitating the construction of Siemens process plants.

### SUMMARY OF THE INVENTION

This invention relates to the production of photovoltaic grade silicon metal, namely silicon with sufficient purity for the manufacture of photovoltaic devices, particularly those commercially used to generate electric power for commercial sale. The process comprises the reaction of liquid silicon tetrachloride (or other tetrahalide) with molten sodium to produce a silicon-containing reaction product, which is then further processed to remove contaminant products that would be detrimental to the performance of the silicon in photovoltaic devices, preferably commercial grade devices used to generate electric power for commercial sale.

One preferred process of the present invention comprises:
(a) introducing the liquid silicon tetrachloride into a reactor vessel containing molten sodium metal, in which the level of molten sodium is controlled to remain within predetermined processing parameters (limits) whereby the sodium is always in stoichiometric excess to the silicon tetrachloride;
(b) separating the reaction product (a mixture of silicon metal, sodium chloride, and sodium metal) from the sodium metal in the reactor vessel; and
(c) removing from the silicon metal the contaminant products that would be detrimental to its performance as a semiconductor for use in photovoltaic devices used to generate electric power.

Preferably, the silicon tetrachloride is introduced into the vessel as a liquid. More preferably, the level of sodium in the vessel is maintained by an automated process within a set of limits that are controlled automatically. Preferably, the silicon-containing reaction product is separated from the sodium under an inert atmosphere.

Another embodiment of the invention is the reaction product formed by this process, which comprises principally elemental silicon metal, sodium chloride, and metallic sodium, in which the mass fraction of metallic sodium is greater than 0.1%. Preferably, the mass fraction of metallic sodium is greater than 1%.

Yet another embodiment of the invention is a process to reduce the mass fraction of metallic sodium in the reaction product, comprising the step of heating the reaction product to a temperature above the boiling point of sodium in an inert atmosphere, driving off the sodium, and thereby reducing the mass fraction of metallic sodium in the product. This process forms a metallic silicon composition produced by the removal of the sodium chloride and sodium metal from the product, in which the metallic silicon is at least 99.999% pure and is suitable for the manufacture of photovoltaic devices used to generate electric power. Preferably, the metallic silicon is at least 99.9999% pure and is suitable for the manufacture of photovoltaic devices used to generate electric power. Preferably, the photovoltaic devices are of commercial grade and the electric power is sold commercially.

In certain preferred embodiments of the present invention, the reaction product contains greater than 0.1% by weight sodium metal after it is separated from the sodium metal in the reactor vessel.

In certain preferred embodiments of the present invention, the reaction product contains greater than 1% by weight sodium metal after it is separated from the sodium metal in the reactor vessel.

In certain preferred embodiments of the present invention, at least half of the sodium contained in the reaction product is removed by heating the reaction product in an inert atmosphere to a temperature greater than 800° C. This heating process can be repeated to achieve any desired degree of silicon purity.

In certain preferred embodiments of the present invention, the silicon metal produced by the process has an average particle size greater than 10 microns.

In certain preferred embodiments of the present invention, the silicon metal produced by the process has an average particle size greater than 100 microns.

Further refinement of this metallic silicon composition can be achieved by the vacuum melting of a metallic silicon composition, whereby the metallic silicon becomes suitable for the manufacture of commercial photovoltaic devices used to generate electric power for commercial sale. Yet another embodiment of the invention is a photovoltaic device produced using any of these metallic silicon compositions of this invention. A further embodiment of this invention is the electricity produced by the photovoltaic devices of the invention.

### BRIEF DESCRIPTION OF THE DRAWINGS

FIG. 1A illustrates a two-vessel design in which a molten sodium reservoir is hydraulically coupled to a reaction vessel with an optional recirculation loop. Point (x) in the reaction vessel is one location for the introduction of silicon halide.

FIG. 1B illustrates a one-reaction vessel design in which Point (x) in the reaction vessel is one location for the introduction of silicon halide, and Point (·) is one location for the introduction of molten sodium in the reaction vessel.

FIG. 2A illustrates the unaided overflow of the reaction product into a collection vessel or system (not shown) under an inert gas such as argon.

FIG. 2B illustrates the mechanical removal of the reaction product from the reaction vessel using mechanical means (e.g., moving belt or screen, etc.) into a collection vessel or system (not shown) under an inert gas such as argon.

### DETAILED DESCRIPTION OF THE PREFERRED EMBODIMENTS

As described above, one preferred process for producing photovoltaic quality silicon metal is to introduce liquid silicon tetrachloride into a reactor containing a stoichiometric excess of molten sodium metal. This reaction produces a material containing sodium chloride, silicon metal, and sodium metal, and this product can be separated from the molten sodium. The reaction consumes the molten sodium in the reactor, so in order to be able to operate continuously or for an extended period of time, the reactor design must include a system to always maintain the level of sodium so as to provide a stoichiometric excess over the rate of addition of silicon tetrachloride.

Moreover, under certain operating conditions the reaction product rises to the surface of the molten sodium and can be removed there. In order to permit the process to operate continuously or for an extended period of time, the reactor design must include an automated system which maintains the level of sodium so as to permit the removal of reaction product to continue for the period of operation.

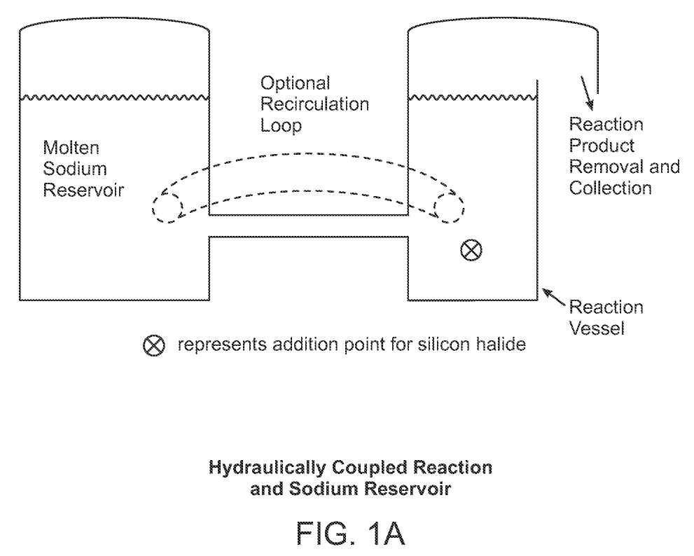

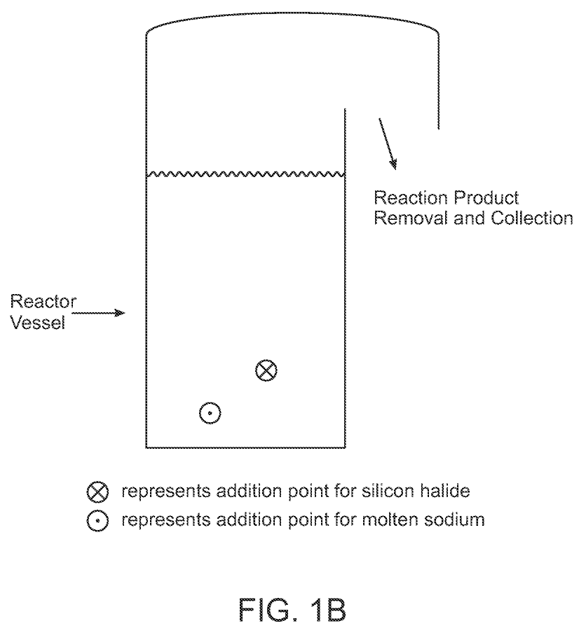

Maintaining the level of molten sodium in the reactor vessel can be accomplished by a number of automated mechanical means. One example comprises a hydraulic coupling to a reservoir of molten sodium in which the level of sodium is separately maintained at a level that is sufficient to achieve the desired processing requirements. Another example comprises means whereby molten sodium can be added directly to the reactor vessel at a rate designed to offset the consumption of molten sodium during the reaction. See FIGS. 1A and 1B.

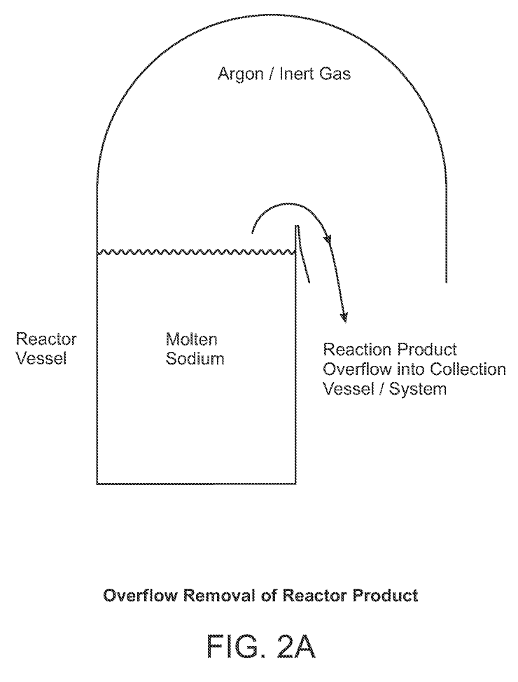

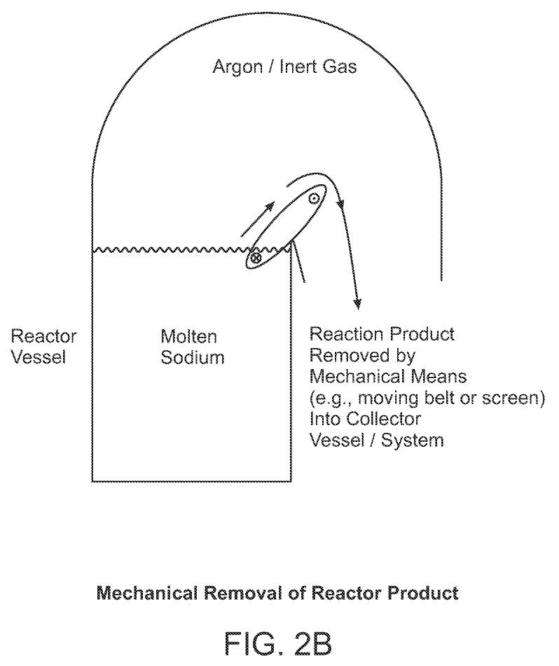

The reaction product, under preferred operating conditions, rises to the surface of the molten sodium and can be removed from there by automated mechanical means. In one example, as the reaction proceeds, the reaction product is allowed to overflow the reactor vessel into a collection vessel (see FIG. 2A). In another example, an automated mechanical means can be used to physically remove the reaction product from the reactor vessel (see FIG. 2B).

The reaction product is comprised principally of sodium chloride and silicon metal, and also contains a quantity of sodium metal. The quantity of this sodium metal in some preferred embodiments of the process can be greater than 0.1% by weight, and in some preferred embodiments of the process can be greater than 1% by weight.

The amount of sodium metal in the reaction product can be reduced by heating the reaction product to a temperature above the boiling point of sodium, in an inert atmosphere. Such a process step can reduce the amount of sodium present in the reaction product by at least 50% as compared to its original amount.

The remaining sodium metal and sodium chloride present in the reaction product can be removed by further processing. Suitable further processing methods include water washing and thermal treatments (e.g., one or more heating steps), which remove the impurities from the reaction product. The methods are repeated until the resulting silicon metal is preferentially at least 99.999% pure, and even more preferentially 99.9999% pure, and in each case is suitable for the manufacture of photovoltaic devices used to generate electric power. Preferably, the photovoltaic devices are of commercial grade and the electric power generated by such devices is sold commercially.

The metallic silicon composition of the present invention, in which the metallic silicon is at least 99.999% pure, preferably at least 99.9999% pure, is suitable for the manufacture of photovoltaic devices used to generate electric power. For example, an ingot of metallic silicon can be produced by the vacuum melting these metallic silicon compositions, as is well known in the art. Such ingots of metallic sodium can be used for the manufacture of photovoltaic devices used to generate electric power, using techniques that are well known in the art.

As used herein, the singular forms “a”, “an” and “the” include plural unless the context clearly dictates otherwise. Moreover, when an amount, concentration, or other value or parameter is given as either a range, preferred range, or a list of upper preferable values and lower preferable values, this is to be understood as specifically disclosing all ranges formed from any pair of any upper range limit or preferred value and any lower range limit or preferred value, regardless of whether ranges are separately disclosed. Where a range of numerical values is recited herein, unless otherwise stated, the range is intended to include the endpoints thereof, and all integers and fractions within the range. It is not intended that the scope of the invention be limited to the specific values recited when defining a range. Other embodiments of the present invention will be apparent to those skilled in the art from consideration of the present specification and practice of the present invention disclosed herein. It is intended that the present specification and examples be considered as exemplary only with a true scope and spirit of the invention being indicated by the following claims and equivalents thereof.

What is claimed is:

1. A process for forming a silicon-containing reaction product comprising the steps of:
(a) introducing silicon tetrachloride into a reactor vessel containing molten sodium metal, in which the level of molten sodium is controlled to remain within predetermined processing parameters whereby the sodium is always in stoichiometric excess to the silicon tetrachloride;
(b) separating the reaction products comprising a mixture of silicon metal, sodium chloride, and sodium metal, from the sodium metal in the reactor vessel; and
(c) removing from the silicon metal a sufficient quantity of the non-silicon products that would be detrimental to the performance of the silicon metal as a semiconductor for use in photovoltaic devices used to generate electric power.

2. The process of claim 1, wherein silicon tetrachloride is introduced into the vessel as a liquid.

3. The process of claim 1, wherein the level of sodium in the vessel is maintained by an automated process within a set of process parameters that are controlled automatically.

4. The process of claim 2, wherein the level of sodium in the vessel is maintained by an automated process within a set of process parameters that are controlled automatically.

5. The process of claim 1, wherein the silicon-containing reaction product is separated from the sodium under an inert atmosphere.

6. The process of claim 2, wherein the silicon-containing reaction product is separated from the sodium under an inert atmosphere.

7. The process of claim 2, wherein at least half of the sodium contained in the reaction product is removed by heating the reaction product in an inert atmosphere to a temperature greater than 800° C.

8. The process of claim 7, wherein the heating process is repeated to further purify the silicon metal.

9. The process of claim 2, wherein the silicon metal has an average particle size greater than 10 microns.

10. The process of claim 2, wherein the silicon metal has an average particle size greater than 100 microns.

11. A reaction product formed by the process of claim 1, comprising principally elemental silicon metal, sodium chloride, and metallic sodium, in which the mass fraction of metallic sodium is greater than 0.1%.

12. A reaction product formed by the process of claim 1, comprising principally elemental silicon metal, sodium chloride, and metallic sodium, in which the mass fraction of metallic sodium is greater than 1%.

13. A process to reduce the mass fraction of metallic sodium in the product of claim 11 or 12, comprising the step of heating the product to a temperature above the boiling point of sodium in an inert atmosphere, and thereby reducing the mass fraction of metallic sodium in the product.

14. A metallic silicon composition produced by the removal of the sodium chloride and sodium metal from the product of either of claim 11 or 12, in which the metallic silicon is at least 99.999% pure and is suitable for the manufacture of photovoltaic devices used to generate electric power.

15. An ingot of metallic silicon produced by the vacuum melting of a metallic silicon composition of claim 14, in which the metallic silicon is suitable for the manufacture of photovoltaic devices used to generate electric power.

16. A metallic silicon composition produced by the removal of the sodium chloride and sodium metal from the product of either of claim 11 or 12, in which the metallic silicon is at least 99.9999% pure and is suitable for the manufacture of photovoltaic devices used to generate electric power.

17. An ingot of metallic silicon produced by the vacuum melting of a metallic silicon composition of claim 16, in which the metallic silicon is suitable for the manufacture of photovoltaic devices used to generate electric power.

18. A photovoltaic device produced from an ingot of metallic silicon of either of claim 15 or 17.
